(19) United States
(12) Patent Application Publication
(10) Pub. No.: US 2003/0133380 A1
(43) Pub. Date: Jul. 17, 2003

(54) Data disc copy protection

(76) Inventor: Yaakov Safrin, Beit Shemesh (IL)

Correspondence Address: DANIEL J SWIRSKY, PO BOX 2345, BEIT SHEMESH, 99544, IL

(21) Appl. No.: 10/046,130

(22) Filed: Jan. 14, 2002

(51) Int. Cl. G11B 7/0045; G11B 7/24

(52) U.S. Cl. 369/53.21; 369/275.3; 369/59.25

(57) ABSTRACT

A method of data disc copy protection is provided including physically damaging at least a portion of a padding area of a data unit stored on a data disc and including a data area and the padding area.

### FIELD OF THE INVENTION

The present invention relates to data disc storage media in general, and particularly to copy protection therefor.

### BACKGROUND OF THE INVENTION

Counterfeiting and piracy of music, software, and other data products and information stored on disc storage media such as compact discs (CDs) and digital video data discs (DVDs) pose a significant problem to copyright holders. While various copy protection and counterfeit detection schemes offer possible solutions to this problem, they often involve modifying the data or the storage medium in close proximity to the data. Such schemes have met with resistance by legitimate consumers who believe that the data is negatively affected. A copy protection scheme that does not directly affect stored data would therefore be advantageous.

### SUMMARY OF THE INVENTION

The present invention provides one or more methods and apparatus for copy-protecting data discs without modifying the data or the storage medium in close proximity to the data.

In one aspect of the present invention a method of data disc copy protection is provided including physically damaging at least a portion of a padding area of a data unit stored on a data disc and including a data area and the padding area.

In another aspect of the present invention the method further includes providing a directory entry on the data disc indicating a storage size of the data unit that is greater than the storage size of the data area and that incorporates the padding area.

In another aspect of the present invention the method further includes configuring the data unit by logically appending the padding area to the logical end of the data area.

In another aspect of the present invention the method further includes configuring the data unit by physically appending the padding area to the physical end of the data area.

In another aspect of the present invention the damaging step includes damaging sufficient to cause a data copying application to abort copying the data unit.

In another aspect of the present invention a method of data disc copy protection is provided including configuring a data disc to include a data unit having a data area and a padding area, and physically damaging at least a portion of the padding area.

In another aspect of the present invention a copy-protected data disc is provided including at least one data unit including a data area and a physically damaged padding area.

In another aspect of the present invention the copy-protected data disc further includes a directory entry on the data disc indicating a storage size of the data unit that is greater than the storage size of the data area and that incorporates the padding area.

In another aspect of the present invention either of the data and padding areas are stored on the data disc in contiguous sectors.

In another aspect of the present invention either of the data and padding areas are stored on the data disc at least partly in non-contiguous sectors.

It is appreciated throughout the specification and claims that the term “data disc” refers to optical, magnetic, or magneto-optical storage media such as, but not limited to, audio, video, audio/video, and data compact discs (CDs) and digital video discs (DVDs). It is further appreciated throughout the specification and claims that the term “data unit” may refer to a data file, an audio file, a song, a movie, or any other known cohesive collection of information that may be stored on a data disc.

The disclosures of all patents, patent applications, and other publications mentioned in this specification and of the patents, patent applications, and other publications cited therein are hereby incorporated by reference in their entirety.

### BRIEF DESCRIPTION OF THE DRAWINGS

The present invention will be understood and appreciated more fully from the following detailed description taken in conjunction with the appended drawings in which:

FIGS. 1A and 1B are simplified pictorial illustrations of a data disc, constructed and operative in accordance with a preferred embodiment of the present invention;

FIG. 2 is a simplified flowchart illustration of a method of data disc copy protection, operative in accordance with a preferred embodiment of the present invention;

FIG. 3 is a simplified flowchart illustration of a method of data disc copy protection, operative in accordance with a preferred embodiment of the present invention; and

FIG. 4 is a simplified pictorial illustration of a data disc, constructed and operative in accordance with a preferred embodiment of the present invention.

### DETAILED DESCRIPTION OF THE INVENTION

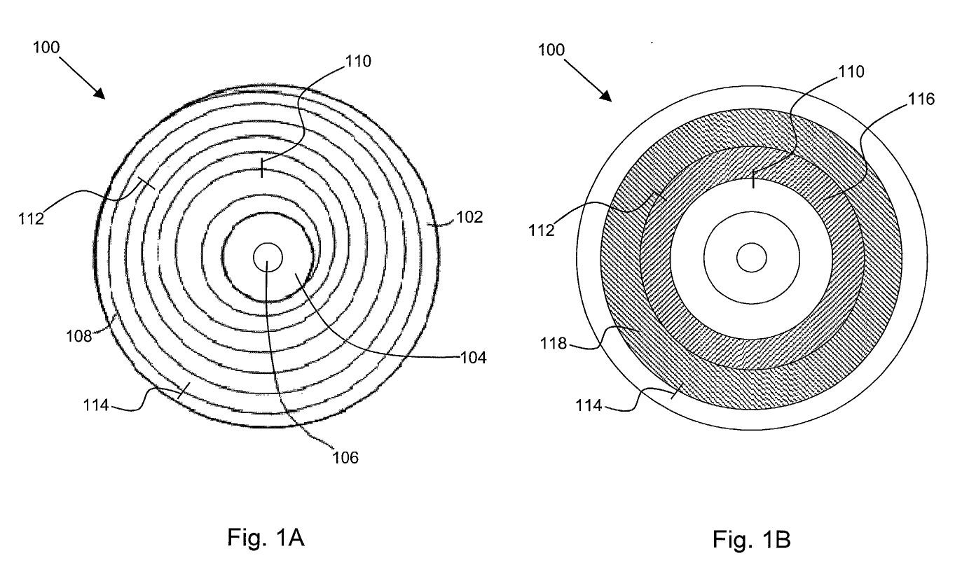

Reference is now made to FIGS. 1A and 1B, which are simplified pictorial illustrations of a data disc 100, constructed and operative in accordance with a preferred embodiment of the present invention. Data disc 100 typically includes a storage area 102 for recording audio, video, or other data, a hub 104, and a spindle hole 106 through which a spindle passes when data disc 100 is played or accessed. A spiral recording track 108, typically being constructed from contiguous sectors, is also shown onto which data are recorded.

A data unit, such as a data file or an audio recording, may be stored between two points along track 108, such as between a data start point 110 and a data end point 112, thereby defining a data storage area 116 as is shown more particularly in FIG. 1B. A non-data storage area 118 may likewise be defined as a portion of track 108 onto which no data has been recorded (or onto which data was previously recorded but whose preservation is no longer desired), such as the portion of track 108 extending from data end point 112 and a non-data end point 114.

Where data disc 100 is a CD or DVD, data disc 100 is typically constructed from a polycarbonate plastic disc onto which protrusions and gaps representing data are formed along track 108. A reflective foil layer, typically being a thin layer of aluminum, copper, silver, or gold, is then deposited onto the plastic layer, covering the protrusions. A lacquer layer is then dripped onto the foil layer and spun at a high speed to create a thin layer of sealant for the foil layer. Lastly, a layer of ink may be screened onto the lacquer layer to form a label.

Digital information is read from optical data discs by a laser which projects through the clear protective plastic of a disc bottom and onto track 108, and is either reflected or not reflected back to the laser reader. From the laser's perspective, the encoded polycarbonate plastic surface is made up of microscopic pits and lands which represent digital ones and zeroes. By reading the reflected light beams, a disc drive decodes the information on a disc.

It is well known that data discs may become physically damaged to the point where data becomes irretrievable. For example, a scratch on the top of a CD or DVD that extends through the reflective foil layer or stamped data will result in lost data and will render the disc irreparable. A scratch on the bottom side of a disc may deflect the laser beam off track, preventing the encoded information from being read.

It is also well known that data disc readers and players, such as CD players and computer-based multimedia players, can compensate for some types of physical damage during real-time access and play, such as by attempting to reconstruct data that cannot be retrieved by using error redundancy and correction techniques, or by interpolating data gaps between two points of successfully read data. However, it has been observed that computer software that is designed to copy data units in their entirety from data discs will generally only do so if there is no damage found within the data unit.

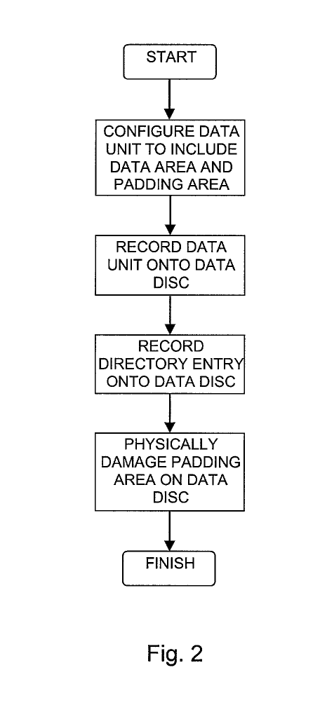

Reference is now made to FIG. 2, which is a simplified flowchart illustration of a method of data disc copy protection, operative in accordance with a preferred embodiment of the present invention. In the method of FIG. 2 a data unit having a data area is configured to include a padding area that does not typically include useful or important data and that is not typically related to the data area data. For example, an MPEG file comprising 1 megabyte of audiovisual data (the data area) may be enlarged to include an additional 200 kilobytes of zero bytes or other byte values that either do not comprise audiovisual data, or that comprise audio and/or visual data that is not necessarily connected to the original MPEG file audiovisual data, such as a visual representation of a blank screen or test pattern (the padding area). The padding area is preferably appended to the logical and/or physical end of the data area. The data unit, now comprising the original data area and the additional padding area, is then recorded onto data disc 100 (FIGS. 1A and 1B). Where the data area is written to track 108 in contiguous sectors it will be seen that the data area may physically occupy data storage area 116. Likewise, where the padding area is written to track 108 in contiguous sectors it will be seen that the padding area may physically occupy non-data storage area 118. A directory entry is typically recorded onto data disc 100 indicating the storage size the data unit. Since the data unit now includes both the original data area and the additional padding area, the directory entry will necessarily indicate that the storage size of the data area is greater than the storage size of the data area.

Once the data unit has been recorded onto data disc 100, some or all of the padding area is physically damaged by physically damaging some or all of non-data area 118 onto which the padding area is stored. It is a particular feature of the present invention that the physical damage is sufficient such that were a hardware and/or software data copying application used to copy the data unit, the data copying application would abort copying the data unit due to the presence of the physical damage within the data unit. Those skilled in the art will appreciate that numerous techniques for physically damaging data disc 100 may be used to such effect, such as by employing a sharp instrument or a laser or other heat source to selectively burn and/or scratch the top and/or bottom of data disc 100 as described hereinabove. Additionally or alternatively, the master that is used to produce data disc 100 may be directly manipulated so that data disc 100 is produced with the desired damage before or during recording of the data unit onto data disc 100.

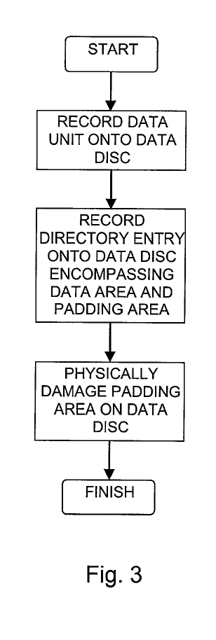

Reference is now made to FIG. 3, which is a simplified flowchart illustration of a method of data disc copy protection, operative in accordance with a preferred embodiment of the present invention. The method of FIG. 3 is substantially similar to the method of FIG. 2 with the notable exception that the data unit is not actively configured to include a padding area prior to recording the data unit onto disc 100. Rather, the data unit is recorded onto data disc 100 as is, i.e. only the data area is recorded onto data disc 100. A directory entry is then recorded onto data disc 100 indicating a storage size that is greater than the the storage size of the data area and that encompasses a region of non-data storage area 118, effectively appending a padding area onto the data area.

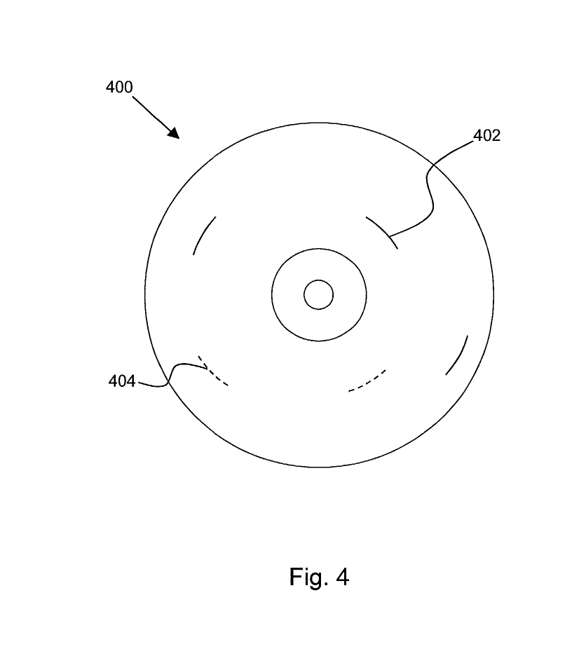

Reference is now made to FIG. 4, which is a simplified pictorial illustration of a data disc 400, constructed and operative in accordance with a preferred embodiment of the present invention. Data disc 400 is substantially similar to data disc 100 (FIGS. 1A and 1B) except as is now noted. It is appreciated that the present invention may be applied equally whether data and padding areas are stored on a data disc in contiguous sectors or at least partly in non-contiguous sectors using conventional techniques. In FIG. 4, a data unit may be stored in along a track in sectors that are at least partly non-contiguous, such as is shown in one or more solid arcs 402 that represent sectors of track 108 (FIG. 1A), while the padding area is stored in non-data storage areas as shown in one or more dashed arcs 404 that represent sectors of track 108 onto which no data has been recorded (or onto which data was previously recorded but whose preservation is no longer desired). When applying either of the the methods of FIGS. 2 and 3, conventional directory information is provided to identify the sector locations of the data and padding areas that comprise the data unit as stored on data disc 400. The padding area may thus be physically damaged by physically damaging one or more of the sectors represented by dashed arcs 404.

It is appreciated that one or more of the steps of any of the methods described herein may be omitted or carried out in a different order than that shown, without departing from the true spirit and scope of the invention.

While the methods and apparatus disclosed herein may or may not have been described with reference to specific hardware or software, it is appreciated that the methods and apparatus described herein may be readily implemented in hardware or software using conventional techniques.

While the present invention has been described with reference to one or more specific embodiments, the description is intended to be illustrative of the invention as a whole and is not to be construed as limiting the invention to the embodiments shown. It is appreciated that various modifications may occur to those skilled in the art that, while not specifically shown herein, are nevertheless within the true spirit and scope of the invention. For instance, the present invention may be applied to magnetic storge media in addition to optical disc storage media.

What is claimed is:

1. A method of data disc copy protection, the method comprising physically damaging at least a portion of a padding area of a data unit stored on a data disc and comprising a data area and said padding area.

2. A method according to claim 1 and further comprising providing a directory entry on said data disc indicating a storage size of said data unit that is greater than the storage size of said data area and that incorporates said padding area.

3. A method according to claim 1 and further comprising configuring said data unit by logically appending said padding area to the logical end of said data area.

4. A method according to claim 1 and further comprising configuring said data unit by physically appending said padding area to the physical end of said data area.

5. A method according to claim 1 wherein said damaging step comprises damaging sufficient to cause a data copying application to abort copying said data unit.

6. A method of data disc copy protection, the method comprising:
configuring a data disc to include a data unit having a data area and a padding area; and
physically damaging at least a portion of said padding area.

7. A copy-protected data disc comprising:
at least one data unit comprising a data area and a physically damaged padding area.

8. A copy-protected data disc according to claim 7 and further comprising:
a directory entry on said data disc indicating a storage size of said data unit that is greater than the storage size of said data area and that incorporates said padding area.

9. A copy-protected data disc according to claim 7 wherein either of said data and padding areas are stored on the data disc in contiguous sectors.

10. A copy-protected data disc according to claim 7 wherein either of said data and padding areas are stored on the data disc at least partly in non-contiguous sectors.
